(19) United States
(12) Patent Application Publication
(10) Pub. No.: US 2026/0251814 A1
(43) Pub. Date: Aug. 27, 2026

(54) Atomic interferometer having improved common-noise rejection

(71) Applicant: DEUTSCHES ZENTRUM FÜR LUFT- UND RAUMFAHRT E.V., Bonn-Oberkassel (DE)

(72) Inventors: Mareike HETZEL, Hannover (DE); Christian SCHUBERT, Hannover (DE); Carsten KLEMPT, Isernhagen (DE)

(21) Appl. No.: 19/333,942

(22) Filed: Sep. 19, 2025

(30) Foreign Application Priority Data
Sep. 23, 2024 (DE) 10 2024 127 355.0

(51) Int. Cl. G01V 7/04

(52) U.S. Cl. CPC G01V 7/04

(57) ABSTRACT

An atomic interferometer has a laser light source, by which first laser light can be emitted at a base frequency, and has at least one light emission device, by which second laser light can be emitted at a frequency which deviates by a differential frequency from the base frequency. The atomic interferometer has an atom trap in which one or more atomic ensembles can be trapped and irradiated using the first and the second laser light.

### FIELD OF THE INVENTION

The invention relates to an atomic interferometer having a laser light source, by which first laser light having a base frequency can be emitted, and having at least one light emission device, by which second laser light having a frequency which deviates by a differential frequency from the base frequency can be emitted, and having an atom trap, in which one or more atomic ensembles can be collected and irradiated using the first and the second laser light.

### BACKGROUND

Atomic-interferometry gravimeters offer absolute gravity measurements having long-term stability. In comparison to the widespread laser gravimeters (FG5X), their measurement principle offers the possibility of quasi-continuous data recording over a relatively long period of time and the perspective of a higher accuracy. Transportable and commercial devices have already been implemented and also operated on a mobile platform such as a ship. An essential component of an atomic-interferometry gravimeter or an atomic interferometer in general is the source for cold atoms. These are typically based on laser cooling in magnetooptical traps and polarization gradient cooling. A three-dimensional magnetooptical trap also requires, in addition to magnetic fields, light fields which are each typically irradiated antiparallel on the three spatial axes in order to form a so-called interaction zone for cooling trapped atoms. This implies a comparatively complex structure having multiple beamforming optical units and corresponding optical accesses to the vacuum system in which the atoms are trapped and cooled. Specially designed pyramid or grid structures have been successfully used for the purpose of creating a beam geometry which can cool effectively in all three spatial axes from a single incident laser beam.

An essential component of an atomic-interferometry gravimeter is the laser system, which generates the laser beams for the interferometry pulses. The interferometry pulses act on the atomic ensemble (i.e. the atom cloud trapped in an interaction zone) in two or more interaction zones in the vacuum system. The atoms are transferred by the interferometry pulses into quantum-mechanical superposition states which are spatially separated from one another and brought together again for interference. The interference signal is sensitive in this case to accelerations, by which a gravimeter can be implemented. The laser beams typically require two different frequency components which are irradiated simultaneously. There are various possibilities for generating these frequency components, in which compromises have to be made between volume, costs, and the purity of the frequency spectrum. One popular solution is the frequency modulation of a laser, for example, by means of acousto-optical or electro-optical modulators (AOMs and EOMs), since they enable a compact and cost-effective laser system. However, undesired frequency components which impair the signal quality also arise due to the generation of the desired frequencies using optical modulators. Since atomic-interferometry gravimeters require laser beams from both vertical spatial directions, the laser beam is often first directed from one direction on the atomic ensemble and reflected back again by a mirror after the passage. Both spatial directions are thus covered.

One important application of gravimeters is their use for gradiometers, in which two spatially separated gravimeters are operated simultaneously. The first derivative of the gravity, the gravitation gradient, can be determined from the differential signal. A common-noise rejection results for the differential signal, in which the gradiometer signal is only worsened by technical noise sources which act differently on the two gravimeters. It is of particular importance here that the two gravimeters are operated as symmetrically as possible in order to benefit maximally from the described noise rejection.

In interferometry, the phase relationships of two waves, in this case of matter waves, are essentially measured. If one wishes to measure the gradient of the gravitation using the atomic interferometer, for example, then the upper atomic interferometer contains the gravitation information about the gravitation at a height h₁ and the lower atomic interferometer contains the gravitation information at a height h₂. The greater the distance is between the atomic interferometers, the greater the differential signal becomes. The following is obtained from atomic interferometer 1 and 2 (shown in simplified form)

$${φ}_{1} = {φ}_{h 1} + {φ}_{interference} ( {h}_{1} ) and {φ}_{2} = {φ}_{h 2} + {φ}_{interference} ( {h}_{2} ) .$$

If the interference is generated by an undesired frequency component, it is periodic with the distance, so that the interference has the same value at different distances. If the gradient is then calculated, the interference terms drop out:

$$Δφ = {φ}_{1} - {φ}_{2} = {φ}_{h 1} + {φ}_{interference} ( {h}_{1} ) - {φ}_{h 2} + {φ}_{interference} ( {h}_{2} ) = {φ}_{h 1} - {φ}_{h 2}$$

The prior art in gradiometry using compact atomic interferometers is described well by publication WO 2014/106811 A2. The gradiometer consists of two (or more) interaction zones. Patent WO 2014/106811 A2 concentrates in this case on the compact and simultaneous generation of multiple atomic clouds by means of pyramid reflectors. Good noise rejection in gradiometers is achieved in that the laser beams for interferometry strike both atomic clouds simultaneously. This is often implemented in that a laser beam having the required frequency components passes all atomic clouds, is reflected on a mirror, and then strikes the atomic clouds again from the opposite direction.

If not only the two required frequency components, but rather still further frequency components are contained in the frequency spectrum of the interferometry light, these frequency components can generate additional phase contributions when reading out the interferometer. These phase contributions can be determined and taken into consideration in the signal analysis. However, uncertainties or noise of the operating parameters limit the characterization of these phase contributions, so that these effects can limit the sensitivity of the gravimeter.

In the gradiometer configuration in which two or more interferometers are operated at a distance to one another, each atomic interferometer experiences its own phase contribution dependent on the distance to the mirror. Since this is not equal for both interferometers, the differential phase contribution can become still greater in the gradiometer than in the gravimeter and likewise limit the sensitivity of the gradiometer.

The optical path length in wave optics is the geometric path length l along a light beam multiplied by the index of refraction n of the propagation medium. The optical path length is therefore, due to the definition of the index of refraction, the path length related to vacuum upon passage of the light through a medium having the index of refraction n and the length l. In other words, the optical path length is the route length for which light in vacuum requires the same time as for a given path having possibly deviating phase speed (the speed at which the wave fronts of the light move forward). If no objects having varying indices of refraction are located in the light beam path of the first and second laser light, the optical path length can also be defined by the geometric path length (called distance hereinafter). Insofar as the term distance is used hereinafter, this includes the optical path length of the respective light beam.

### SUMMARY

The invention is based on the object of specifying an improved atomic interferometer.

This object is achieved in an atomic interferometer of the type mentioned at the outset in that
a) in the case of multiple atomic ensembles, the optical path length between two atomic ensembles, which are assigned to one another as a pair and form a gradiometer arrangement, corresponds to half the wavelength or an integer multiple of half the wavelength of the differential frequency or another interference frequency
and/or
b) the optical path length between an atomic ensemble and a mirror of the atomic interferometer reflecting the first and the second light corresponds to half the wavelength or an integer multiple of half the wavelength of the differential frequency or another interference frequency.

Therefore, if the distance between the two atomic interferometers or their two atomic ensembles in the gradiometer configuration are not arbitrary, but rather are optimally selected, in this way the differential phase offset between the interferometers can be suppressed. The phase contributions in the atomic interferometer due to undesired frequency components display a periodic behavior upon the change of the distance between the two atomic ensembles or between mirror and atomic ensemble. The periodicity of the effect is given by half the wavelength of the undesired modulation frequency. If this frequency is already known in the development phase of the gradiometer, the distance between the interferometers can be optimized. If the distance between the two atomic interferometers is precisely a multiple of half the wavelength of the undesired modulation frequency, the atomic interferometers experience the same phase contribution at all times, so that it falls out in the differential analysis in the gradiometer.

The mentioned distance value or the value of the optical path length does not necessarily have to be reached entirely exactly here; even approximately reaching the desired value brings about a significant improvement of the accuracy and noise rejection of the atomic interferometer.

The invention can be used not only to compensate for interference effects generated by the differential frequency, but also to compensate for interference effects which are generated by any other interference frequencies modulated onto the first laser light.

The invention is analogously applicable to a system having three or more atomic interferometers or their atomic ensembles, which are located at a defined distance.

The invention can also be applied to individual atomic interferometers of any type. If the optical path length between the atomic ensembles and the mirror does not change or hardly changes, as in the case of gyroscopes, for example, the distance between the atomic ensembles and the mirror can be selected so that it corresponds to a multiple of half the wavelength of the interference frequency, so that the applied phase offset is zero for all interferometry pulses. If the distances to the mirror change, the distances between the interaction zones can be selected so that they correspond to a multiple of half the wavelength of the interference frequency.

In one advantageous design, the optical path length between the two atomic ensembles (in the case of a pair of atomic ensembles) or the optical path length between one atomic ensemble and the mirror can correspond to at least two times, three times, or four times half the differential frequency. This has the advantage that in this way practical geometric dimensions can be achieved which are in the range of several centimeters for the optical path length. Accordingly, known atomic interferometers do not have to be completely changed with respect to their mechanical construction, but rather only brought to a moderate extent to the desired distance value.

According to one advantageous design of the invention, the atomic interferometer is configured to carry out Raman interferometry. In this case, for example, Raman light interferometry sequences can be executed by the atomic interferometer. The first laser light and the second laser light deviating therefrom by the differential frequency are used here to apply various pulse states to the atoms used.

According to one advantageous design of the invention, it is provided that the atomic interferometer is designed as a gradiometer in which two atomic ensembles assigned to one another as a pair form the gradiometer arrangement. Using such a gradiometer, measurements of the gravitational field can be carried out with particularly good sensitivity, in particular to determine the gravitation gradient of the gravitational field.

According to one advantageous design of the invention, it is provided that the atomic interferometer is designed as a gravimeter. Using such a gravimeter, absolute gravity measurements having long-term stability can be carried out with particularly good sensitivity.

According to one advantageous design of the invention, it is provided that the light emission device is designed as an optical modulator by which the first laser light is convertible by optical modulation into the second laser light. This enables the second laser light, which deviates by the differential frequency from the base frequency of the first laser light, to be provided easily and reliably. The optical modulator can be designed, for example, as an electro-optical modulator or acousto-optical modulator. The second laser light can therefore be generated by irradiating an optical modulator using the first laser light of the laser light source or another light source which emits first laser light having the base frequency, and actuating the optical modulator using the desired differential frequency. It is also possible to generate the second laser light by way of a second laser light source separate from the first laser light source, in order to emit the second laser light deviating by the differential frequency from the base frequency directly, i.e. without an additional optical modulator.

According to one advantageous design of the invention, it is provided that the optical path length between two atomic ensembles assigned to one another as a pair is defined by the distance between the starting and/or end locations of two interferometers formed by the atomic ensembles.

According to one advantageous design of the invention, it is provided that the optical path length between two atomic ensembles assigned to one another as a pair is defined by the distance between two interferometry interaction zones. Accordingly, the atomic interferometer can be implemented having improved sensitivity in its construction in a simple manner. For example, two pyramidal mirrors as described, for example, in WO 2014/106811 A2 can be arranged with respect to their distance such that the distance or the resulting optical path length corresponds to half the wavelength or an integer multiple of half the wavelength of the differential frequency or another interference frequency.

In general, it can be stated that the desired distance value can be defined by defining the distance of the interferometry interaction zones from one another and/or an interferometry interaction zone from the mirror.

According to one advantageous design of the invention, it is provided that the optical path length between two atomic ensembles assigned to one another as a pair is defined by beam splitter operations (momentum transmission by atom-light interaction). In this way, for example, the sensitivity of a gravimeter can be improved in a simple manner.

According to one advantageous design of the invention, it is provided that the optical path length of an atomic ensemble from a mirror reflecting the first and the second light is defined by the distance of an interferometry interaction zone, for example a magnetooptical trap, from the mirror. For example, the desired distance value can be defined by the distance of a pyramidal mirror from the mirror.

In this case, locations at which the respective atomic ensembles are irradiated using the interferometry light pulses are viewed as interferometry interaction zones. The location of the atoms is initially determined by the position of the magnetooptical trap and possibly changes in the course of the interferometry sequence due to the movement of the atoms in the free trap and therefore the location of the interferometry interaction zones also changes.

The invention is suitable for various areas of application, e.g.:

### Geophysical Applications:

monitoring volcanoes
monitoring seismic activities
hydrology

### Exploration:

raw material exploration
groundwater management

### Engineering:

monitoring the stability of roads, dams, and dikes
preparing gravitational field maps, detecting cavities in urban development and in mining regions

### DESCRIPTION OF THE DRAWINGS

The invention will be explained in more detail hereinafter on the basis of exemplary embodiments using drawings.

In the figures

FIG. 1 shows an atomic interferometer in a schematic representation,

FIG. 2 shows light frequency bands in the atomic interferometer,

FIG. 3 shows a first embodiment of a distance-optimized atomic interferometer,

FIG. 4 shows a second embodiment of a distance-optimized atomic interferometer.

### DETAILED DESCRIPTION

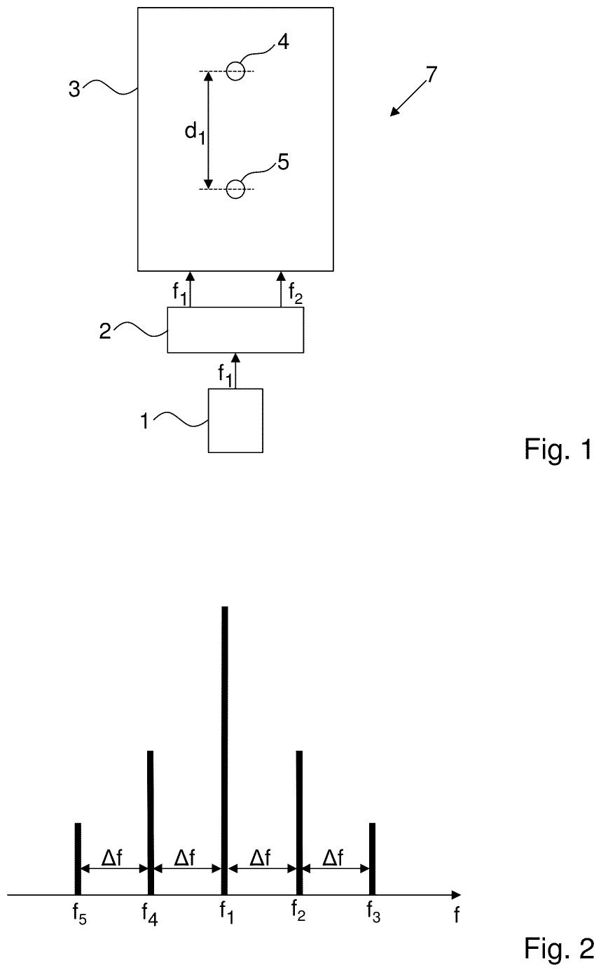

FIG. 1 shows an atomic interferometer 7 which can be designed, for example, as a gradiometer or gravimeter. The atomic interferometer 7 has a laser light source 1, by which first laser light having a base frequency f₁ is emitted. The atomic interferometer 7 additionally has a light emission device 2, for example having an optical modulator, by which second laser light having a frequency f₂ can be emitted. The frequency f₂ is different here by a differential frequency Δf from the base frequency f₁.

The atomic interferometer 7 additionally has an atom trap 3, in which multiple atomic ensembles 4, 5 are trapped at predefined positions, i.e. at interaction zones, and are irradiated using the first and the second laser light, therefore at the different frequencies f₁, f₂. The atom trap 3 can be designed, for example, as a magnetooptical trap (MOT) as described in detail, for example in WO 2014/106811 A2.

The irradiation of the atomic ensembles 4, 5 using laser light, which only has the frequencies f₁, f₂, shown in FIG. 1 is an idealized assumption in this case, in which the effect occurring in practice is neglected that not only the one desired frequency side band f₂ is generated by an optical modulator which is actuated at the differential frequency Δf, but rather further undesired side bands f₃, f₄, f₅, . . . etc., as shown in FIG. 2. As can be seen, the side bands are all spaced apart from one another by the differential frequency Δf.

One advantageous element for use in atomic-interferometry apparatuses is rubidium, particularly the isotope Rb-87. Light of the wavelength 780 nm is required for the operation of the interferometric light pulses. In this case two frequencies f₁, f₂ are required, which have a distance Δf of 6.835 GHz. One of the frequencies can be, for example, the base frequency of the laser source 1. The second frequency can be applied to the light of this laser 1 by the use of an electro-optical modulator using a modulation at 6.835 GHz. The above-explained side bands arise here, which each have a distance of the selected differential frequency Δf and its multiples.

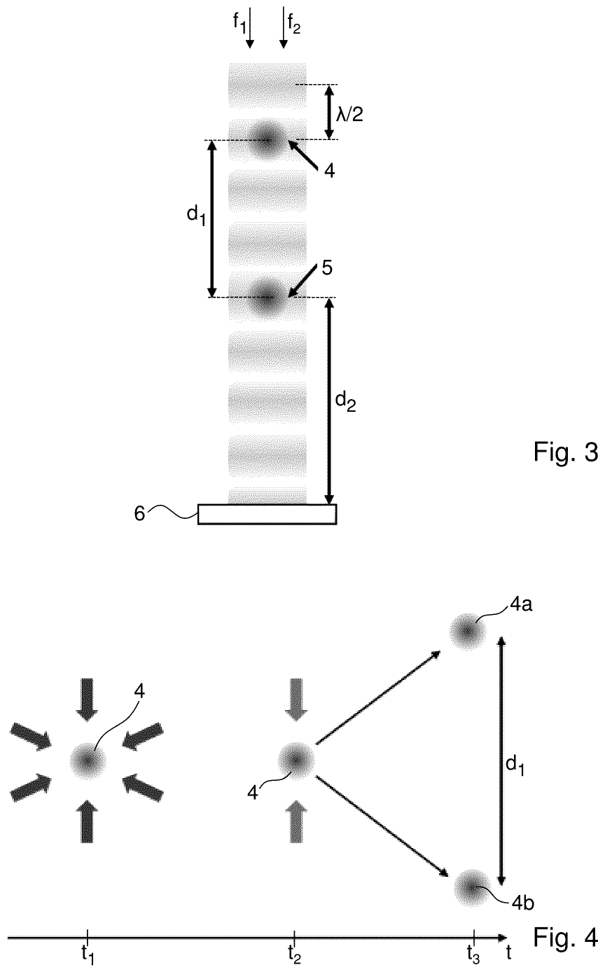

The undesired frequency side bands result in a phase shift of the interferometry signal. In the gradiometer configuration with arbitrarily selected distance, both interferometers experience a different phase shift, so that a differential phase shift results. This differential phase shift is avoided, as shown in FIG. 3, if the optical path length d₁ between the two atomic ensembles 4, 5, which are assigned to one another as a pair and form a gradiometer arrangement, is selected so that it corresponds to a multiple of half the wavelength λ/2 of the frequency side band of the 6.835 GHz frequency, thus λ/2=c/Δf=21.9 mm, wherein c is the speed of light. If an optical path length d₁ of 219 mm is thus selected, for example, i.e. a multiple of 10 times, the interferometers experience the same phase shift for all parameters, so that it does not influence the gradiometer signal.

As FIG. 3 shows, additionally or alternatively the optical path length d₂ between an atomic ensemble 4, 5 and a mirror 6 of the atomic interferometer 7 reflecting the first and the second light can be set to such an optimum distance, namely a multiple of half the wavelength λ/2 of the frequency side band.

In addition, as FIG. 4 shows, in an atomic interferometer in which, for example, only one atomic ensemble 4 is trapped in the atom trap 3, noise rejection can also be carried out by such a distance optimization. FIG. 4 shows a time sequence plotted over the time t. At a time t₁, the atomic ensemble 4 in the atom trap 3 is irradiated using the laser light, as illustrated by the arrows. During the further steps of the sequence therein, an optimum optical path length d₁ is established. For example, by way of a beam splitter operation at the time t₂, the one atomic ensemble 4 can be divided into two partial ensembles 4a, 4b separate from one another such that their distance d₁ from one another again corresponds to the mentioned optimum distance, thus a multiple of half the wavelength λ/2 of the frequency side band. The beam splitter operation can be carried out, for example, by further irradiated laser light, as illustrated by the arrows at time t₂.

1. An atomic interferometer, comprising:
a laser light source by which a first laser light is emittable at a base frequency;
least one light emission device by which a second laser light is emittable at a frequency which deviates from the base frequency a differential frequency; and
an atom trap in which one or more atomic ensembles are trappable and irradiatable using the first laser light and the second laser light,
wherein in a case of multiple atomic ensembles, an optical path length between two atomic ensembles of the multiple atomic ensembles which are assigned to one another as a pair and form a gradiometer arrangement, and the optical path length corresponds to half wavelength of the differential frequency or an integer multiple of half the wavelength of the differential frequency or another interference frequency
and/or
wherein a second optical path length between an atomic ensemble and a mirror of the atomic interferometer reflecting the first light and the second light corresponds to half the wavelength of the differential frequency or an integer multiple of half the wavelength of the differential frequency (Δf) or another interference frequency.

2. The atomic interferometer as claimed in claim 1 wherein the atomic interferometer is designed as a gradiometer, in which two atomic ensembles assigned to one another as a pair form a gradiometer arrangement.

3. The atomic interferometer as claimed in claim 1 wherein the the atomic interferometer is designed as a gravimeter.

4. The atomic interferometer as claimed in claim 1 wherein the at least one light emission device is designed as an optical modulator by which the first laser light is convertible into the second laser light by optical modulation.

5. The atomic interferometer as claimed in claim 1 wherein the optical path length between the two atomic ensembles assigned to one another as a pair is defined by a distance of a starting location and/or an end location of two interferometers from one another.

6. The atomic interferometer as claimed in claim 1 wherein the optical path length between the two atomic ensembles assigned to one another as a pair is defined by a distance of two interferometry interaction zones from one another.

7. The atomic interferometer as claimed in claim 1 wherein any the optical path length between the two atomic ensembles assigned to one another as a pair is defined by beam splitter operations.

8. The atomic interferometer as claimed in claim 1 wherein the optical path length of an atomic ensemble to a mirror reflecting the first light and the second light is defined by a distance of an interferometry interaction zone from the mirror.
